(19) United States
(12) Patent Application Publication
(10) Pub. No.: US 2006/0164300 A1
(43) Pub. Date: Jul. 27, 2006

(54) Transmit antenna

(76) Inventor: Robert Montague Ellard, Elizabeth East (AU)

Correspondence Address: DORSEY & WHITNEY LLP, 555 CALIFORNIA STREET, SUITE 1000, SUITE 1000, SAN FRANCISCO, CA, 94104, US

(21) Appl. No.: 10/534,213

(22) PCT Filed: Nov. 6, 2003
(86) PCT No.: PCT/AU03/01465

§ 371 Date: Feb. 28, 2006

(30) Foreign Application Priority Data
Nov. 6, 2002 (AU) 2002952531

(51) Int. Cl. H01Q 3/12; H01Q 11/10; H01Q 1/48; H01Q 1/50

(52) U.S. Cl. 342/374; 343/792.5; 343/846; 343/852

(57) ABSTRACT

A transmit antenna for a surface wave radar system, including a linear array of active monopole antenna elements for transmitting signals in respective frequency ranges. The relative spacings and the relative heights of successive elements along the array have logarithmic relationships. The transmit antenna includes impedance matching circuits for the active monopole antenna elements, and switches for selecting one of the active antenna elements to transmit a signal in a corresponding frequency range while grounding the remaining active antenna elements.

### FIELD OF THE INVENTION

The present invention relates to a transmit antenna, and in particular to an antenna for transmitting signals for high frequency surface wave radar.

### BACKGROUND

High frequency surface wave radar (HFSWR) systems have been developed to overcome the line-of-sight limitation of microwave radar systems. HFSWR exploits a phenomenon known as a Norton wave propagation, whereby a vertically polarised electromagnetic signal propagates efficiently as a surface wave along a conducting surface. HFSWR systems operate from coastal installations, with the ocean providing the conducting surface. The transmitted signal follows the curved ocean surface, and an HFSWR system can detect objects beyond the visible horizon, with a range of the order of 300 km.

As shown in FIG. 1, a surface wave radar system includes a transmitter 12, and a receiver 14. The transmitter 12 includes transmitter electronics 18 and a transmitting antenna 16. The transmitting antenna 16 is a directional broadband antenna, such as a log-periodic antenna array, capable of generating a substantial surface wave and a relatively insubstantial overhead skywave. The transmitting antenna 16 transmits high frequency (5-10 MHz) electromagnetic surface wave signals from a shoreline 26 across the ocean surface. The transmitted signals are reflected from objects such as a ship 28, and reflected surface wave signals are received by the receiver 14.

The receiver 14 includes a data processing system 24 and a broadside array 20 of vertically polarised antenna doublets. The broadside array 20 is oriented approximately perpendicular to a principal receiving direction 25 for reflected surface wave signals, and, in this case, is approximately parallel to the shore 26. The receiver 14 can also include an endfire array 22 of vertically polarised monopole antenna elements, oriented perpendicular and adjacent to the broadside array 20 to form a two-dimensional (2-D) receiving antenna array.

A standard log-periodic antenna array is suitable for the directional transmission of vertically polarised signals over a wide bandwidth and beam width. However, it is often necessary to transport the antenna to various locations. Log-periodic antenna arrays designed to transmit signals in the appropriate frequency range (5-10 MHz) are large and expensive structures that require considerable effort for disassembly, transportation, site preparation and reassembly. It is desired, therefore, to provide a transmit antenna that alleviates one or more of these difficulties, or at least provides a useful alternative to existing transmit antennas.

### SUMMARY OF THE INVENTION

In accordance with the present invention, there is provided a transmit antenna for a surface wave radar system, including:

a linear array of active monopole antenna elements for transmitting signals in respective frequency ranges, the relative spacings and the relative heights of successive elements along the array having substantially logarithmic relationships;

impedance matching circuits for the active monopole antenna elements; and

switch means for selecting one of the active antenna elements to transmit a signal in a corresponding frequency range while grounding the remaining active antenna elements.

### BRIEF DESCRIPTION OF THE DRAWINGS

A preferred embodiment of the present invention is hereinafter described, by way of example only, with reference to the accompanying drawings, wherein:

FIG. 1 is a schematic diagram of a surface wave radar system;

FIGS. 2 to 4 are schematic diagrams of a preferred embodiment of a transmit antenna of the radar system;

FIG. 5 is a graph of voltage standing wave ratio (VSWR) as a function of frequency for each impedance matched antenna element of the transmit antenna; and

FIGS. 6 to 11 are graphs of the simulated and measured radiation patterns from each antenna element with impedance matching, at frequencies of 5.1, 6.1, 7.1, 8.1 9.1, and 10.2 MHz, respectively.

### DETAILED DESCRIPTION OF THE PREFERRED EMBODIMENT

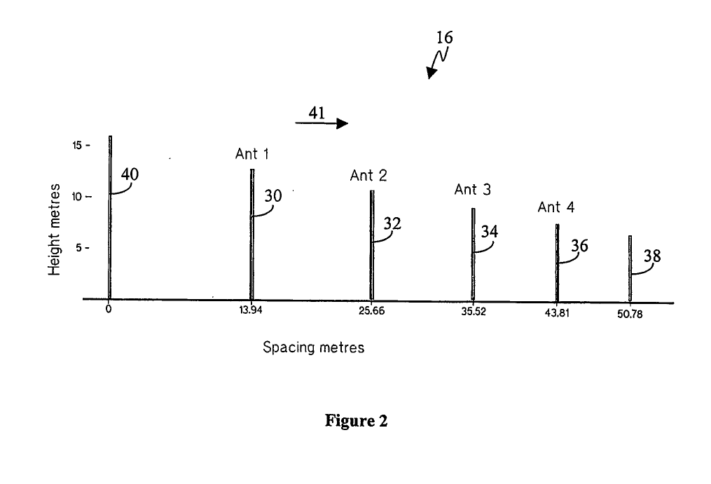

As shown in FIG. 2, a transmit antenna 16 includes a linear array of four active base-fed monopole antenna elements 30 to 36 and two passive elements 38, 40, at respective ends of the array. Each of the active monopole elements 30 to 36 transmits signals in a unique portion of the antenna's 5-10 MHz frequency transmission range, as shown in Table 1.

TABLE 1

| | | | | frequency |
|---|---|---|---|---|
| | height | position | spacing | range |
| element | (m) | (m) | (m) | (MHz) |
| passive | 16.00 | 0 | — | — |
| reflector (40) | | | | |
| Element 1 (30) | 12.78 | 13.94 | 13.94 | 5.0-5.7 |
| Element 2 (32) | 10.75 | 25.66 | 11.72 | 5.7-7.1 |
| Element 3 (34) | 9.04 | 35.52 | 9.86 | 7.1-8.15 |
| Element 4 (36) | 7.60 | 43.81 | 8.29 | 8.15-10.0 |
| passive director | 6.39 | 50.78 | 6.97 | — |
| (38) | | | | |

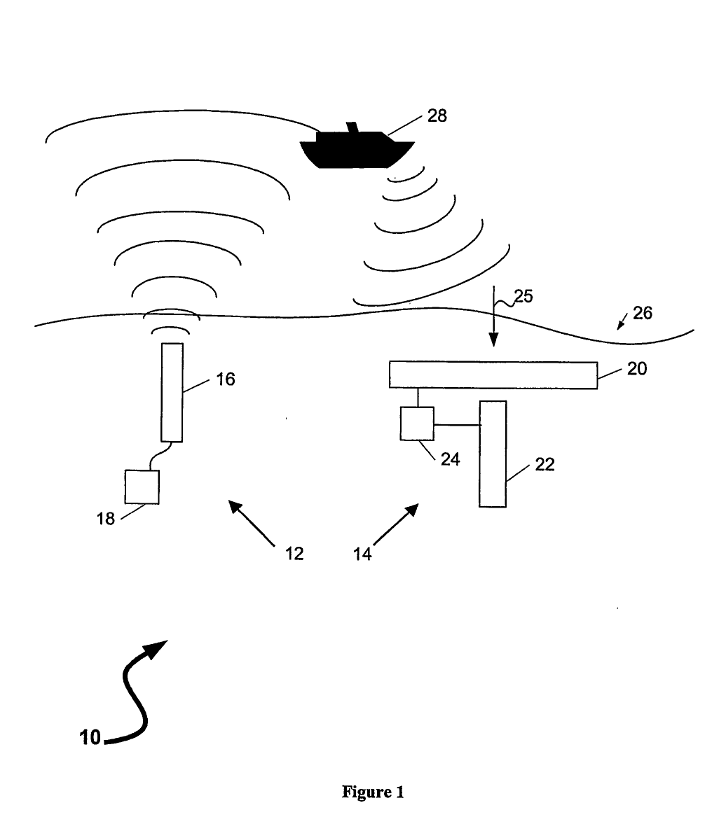

The tallest passive element 40 is a sixteen metre wind-up lattice mast and acts as a reflector at the low frequency end of the antenna's operating frequency range. The other passive element 38 is shorter and acts as a director at the high frequency end of the antenna's operating frequency range. Thus the maximum transmit signal intensity is directed along the array direction 41 leading away from the reflector passive element 40 toward the director passive element 38, and accordingly the transmit antenna 16 is oriented so that this direction 41 points towards the potential objects of interest; i.e., in the arrangement of FIG. 1, pointing away from the shoreline 26 towards the ocean. The six elements 30 to 40 have logarithmic relationships in height and position within the antenna array, as can be determined from the data of Table 1. That is, the height h of the n^{th} (passive or active) antenna element can be represented as log(h)=a−bn, where a and b are real numbers. Similarly, the spacing s of the n^{th} antenna element from the (n−1)^{th} antenna (passive or active) element can be represented as log(s)=c−dn, where c and d are real numbers. The specific values for the heights and positions are determined using standard antenna design software such as numerical electromagnetic code (NEC) and SPICE.

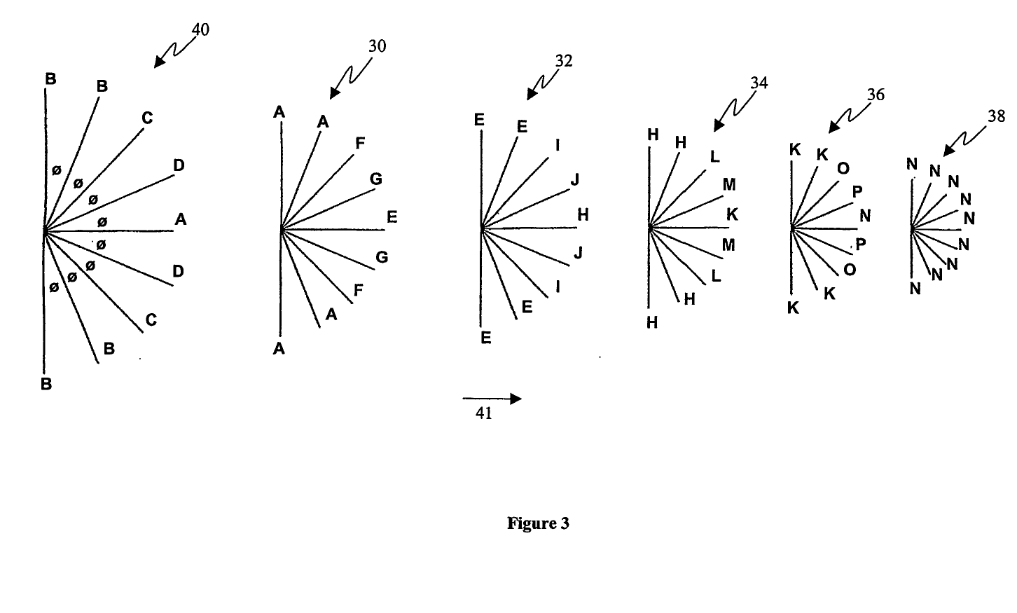

A grounded radial wire counterpoise under each antenna element reduces ground losses and stabilises the impedance of each antenna element under varying ground conditions. The configurations of the counterpoises are shown in a plan view of the transmit antenna 16 in FIG. 3. Viewed from above, the nine wires of each counterpoise extend radially from one side of the base of the corresponding antenna element, with each adjacent pair of wires being separated by an angle φ=22.5°. Thus the wires of each counterpoise form a semicircular region oriented towards the high frequency end of the antenna array. Eight different wire lengths are used to form the counterpoises, referred to as wires A to H, as shown in Table 2. The selection and arrangement of wires A to H in each counterpoise is provided in FIG. 3.

TABLE 2

| Wire | Length (m) |
|---|---|
| A | 13.9 |
| B | 17 |
| C | 20 |
| D | 16 |
| E | 11.27 |
| F | 16.25 |
| G | 12.45 |
| H | 9.16 |
| I | 13.27 |
| J | 10.16 |
| K | 7.846 |
| L | 11.4 |
| M | 8.73 |
| N | 6.52 |
| O | 9.54 |
| P | 7.3 |

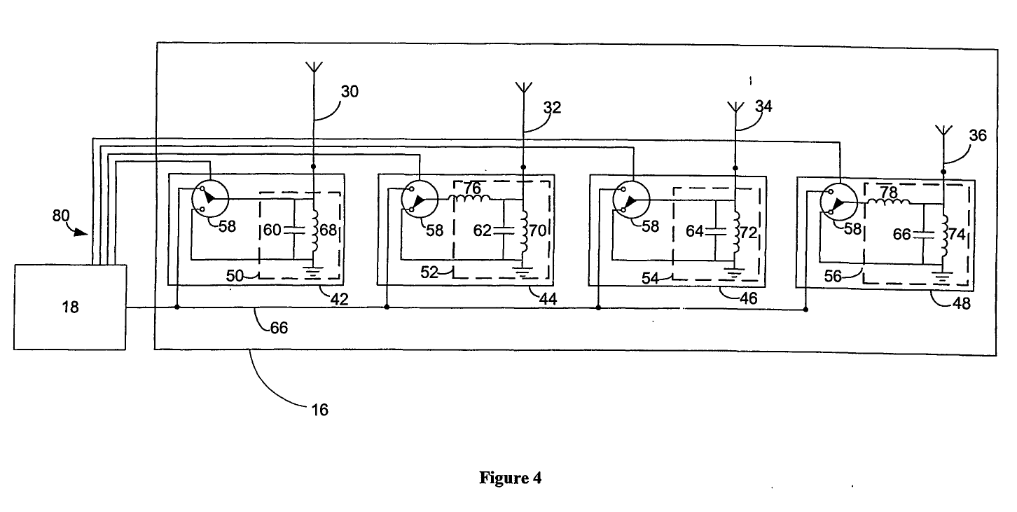

As shown in FIG. 4, the antenna includes interface modules 42 to 48 for interfacing the respective monopole elements 30 to 36 to the transmitter electronics 18. Each of the interface modules 42 to 48 includes a respective two or three element LC impedance matching network 50 to 56 and a standard high-power latching radio-frequency (RF) power relay or switch 58. The impedance matching networks 50 to 56 each include a respective capacitor 60 to 66 and inductor 68 to 74 in parallel with the transmitter signal; the second (second lowest frequency) network 42 and the fourth (highest frequency) network 46 also include an additional inductor 76, 78 in series with the signal.

The RF switches 58 allow each antenna element to be independently connected to the transmitter electronics 18 via the coaxial cable 76, or shorted to ground potential. When a signal of a particular frequency is transmitted, the antenna element whose allotted frequency range includes that frequency is connected to the transmitter electronics 18, and the three remaining antenna elements are shorted to ground. This switching is performed by remotely controlling the switches 58 to 64 by sending appropriate signals on control cables 80. Specifically, a 24-volt gate pulse signal sent to one of the RE switches 58 to 64 on that switch's control cable activates the RF switch to connect the coaxial cable 76 to the corresponding interface module (e.g., the second interface module 44), and thereby to the corresponding antenna element (e.g., the second antenna element 32). The other antenna elements (e.g., the first, third and fourth antenna elements 30, 34, 36) are shorted to ground and act as additional reflectors or directors.

Table 3 provides details of the values of capacitance and inductance for each of the active antenna element matching networks 50 to 56.

TABLE 3

| | parallel | series | parallel |
|---|---|---|---|
| | capacitance | inductance | inductance |
| element | (pF) | (μH) | (μH) |
| passive | — | — | — |
| reflector (40) | | | |
| Element 1 (30) | 2578 | — | 0.339 |
| Element 2 (32) | 1557.4 | 0.574 | 0.438 |
| Element 3 (34) | 1276.8 | — | 0.330 |
| Element 4 (36) | 1339.5 | 0.400 | 0.244 |
| passive director | — | — | — |
| (38) | | | |

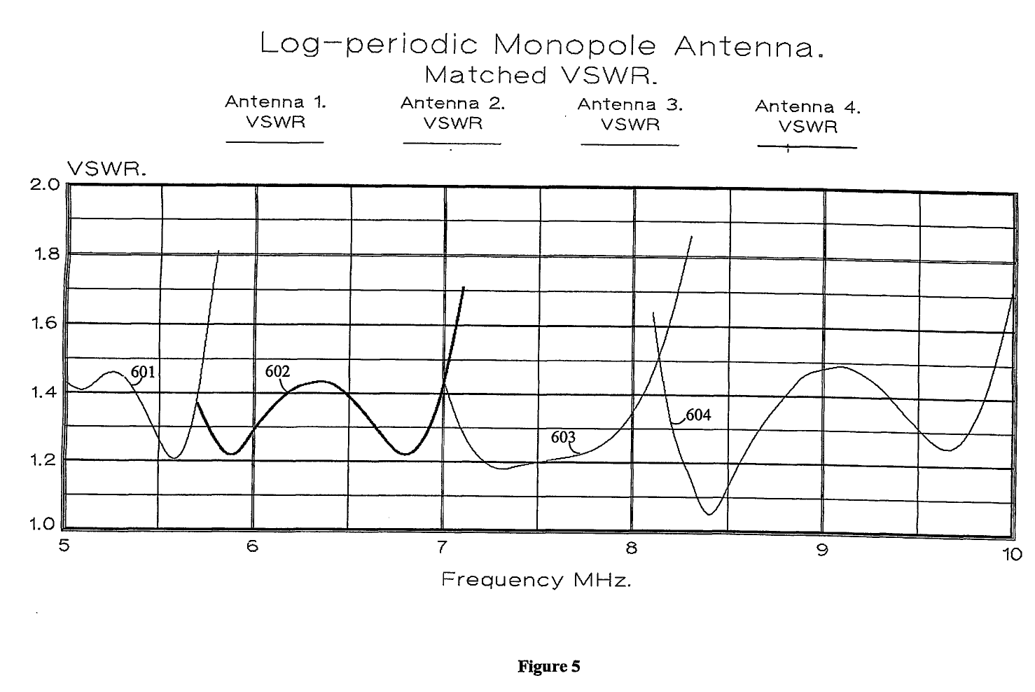

As shown in FIG. 5, the voltage standing wave ratios (VSWRs) 601 to 604 for the four antenna elements 30 to 36 are predominantly between 1.2:1 and 1.4:1 over the entire operating frequency range of the antenna 16.

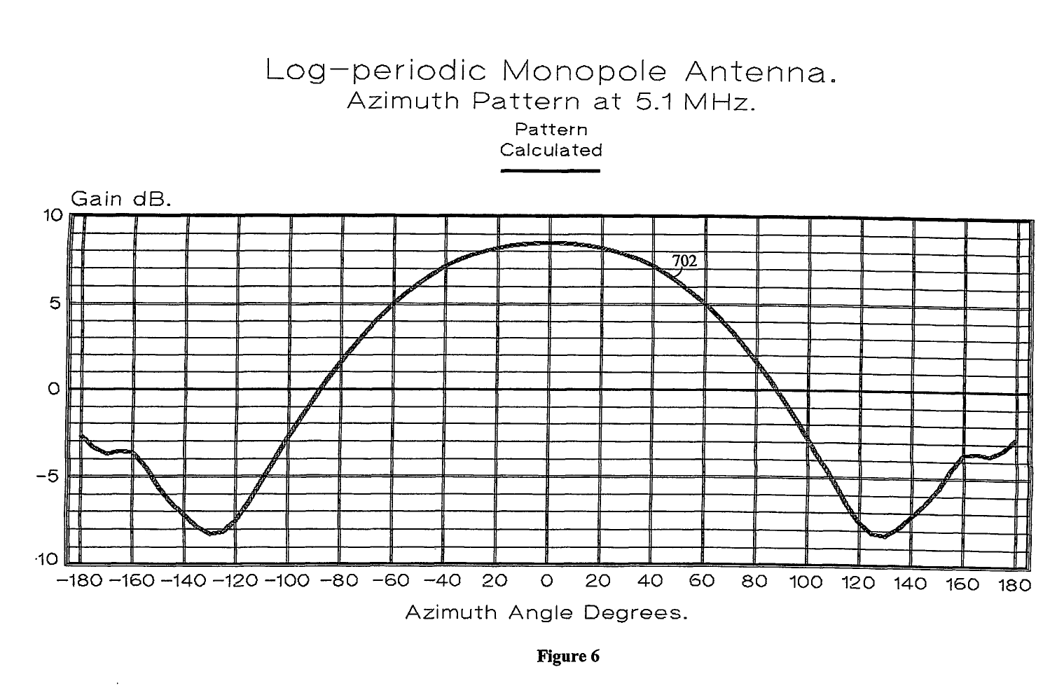

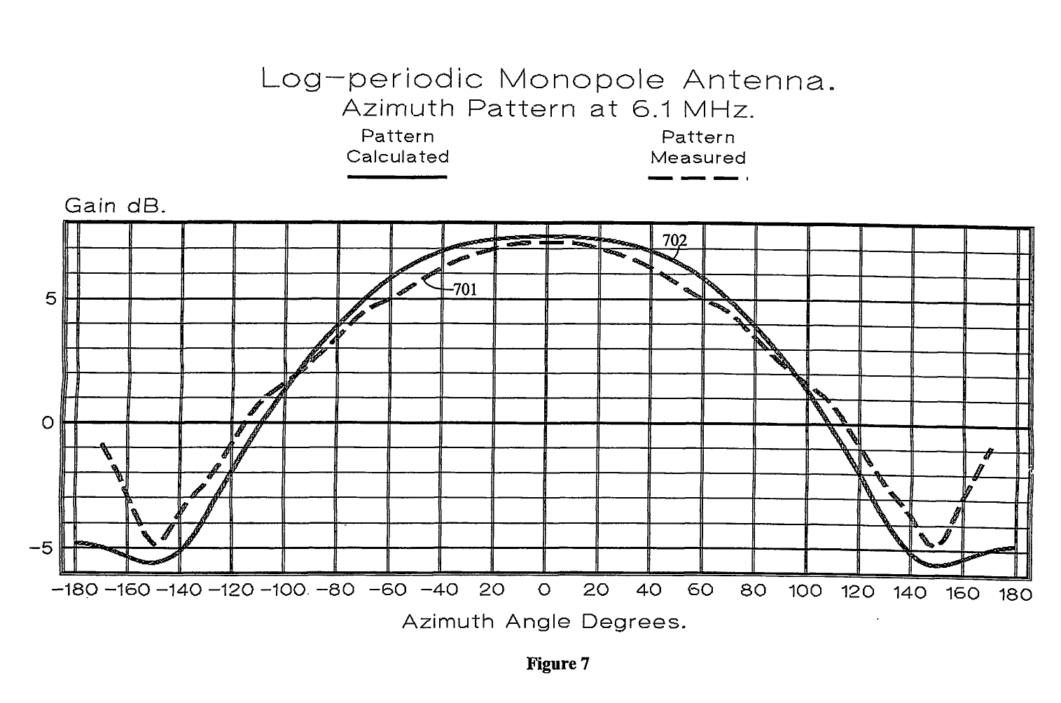

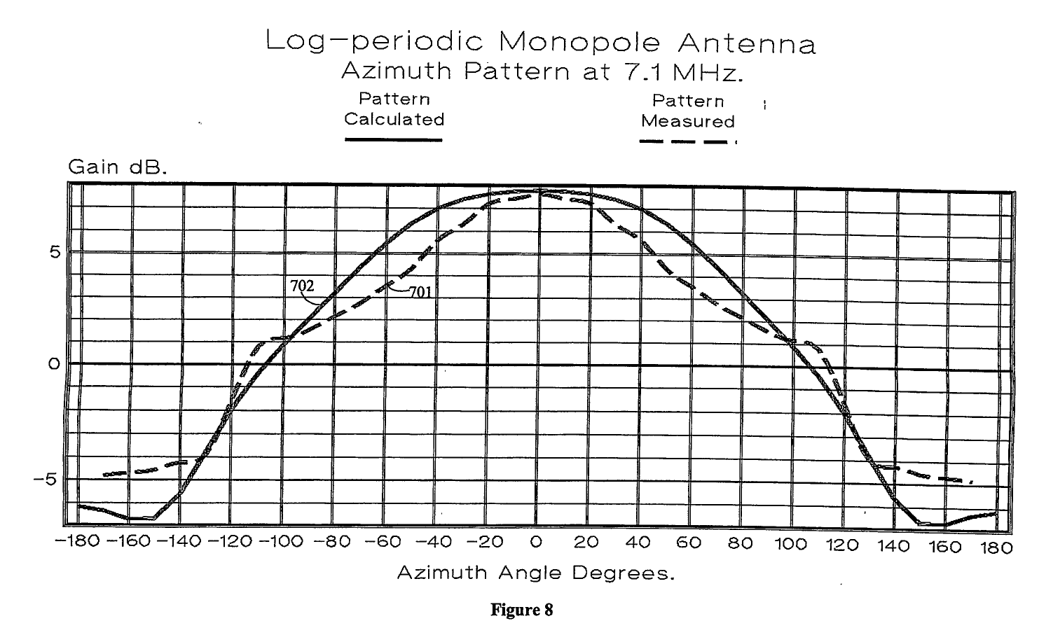

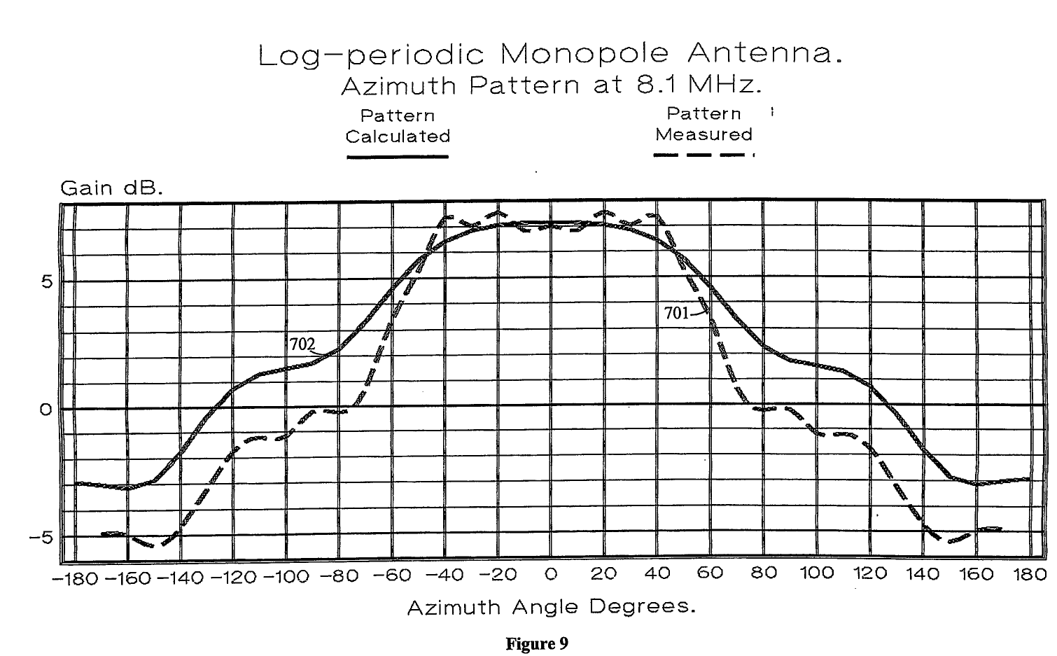

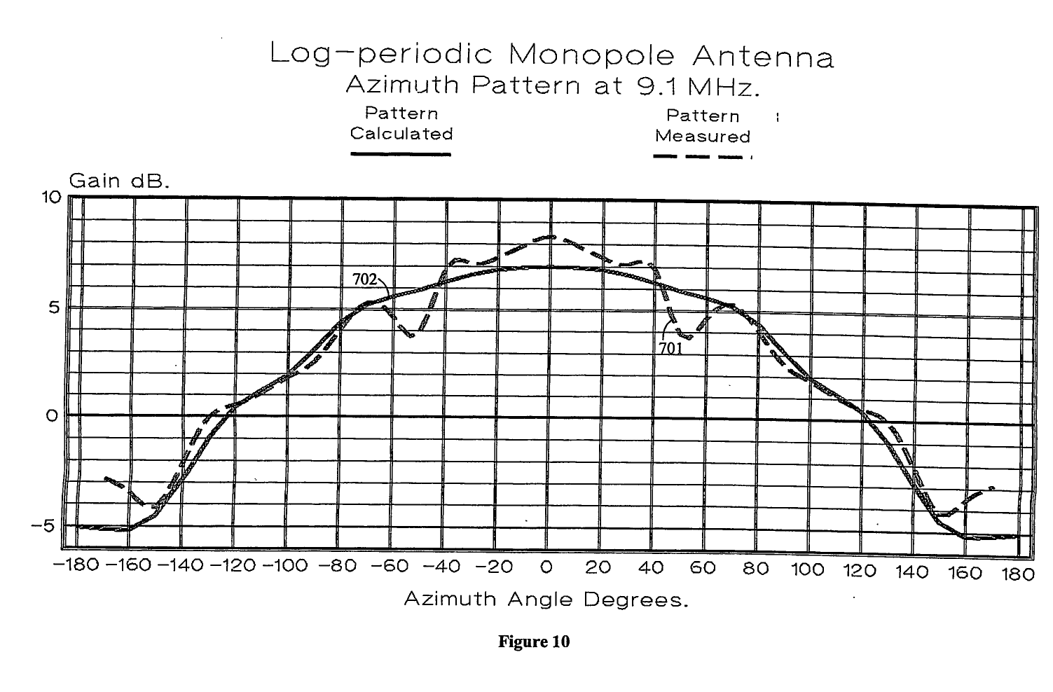

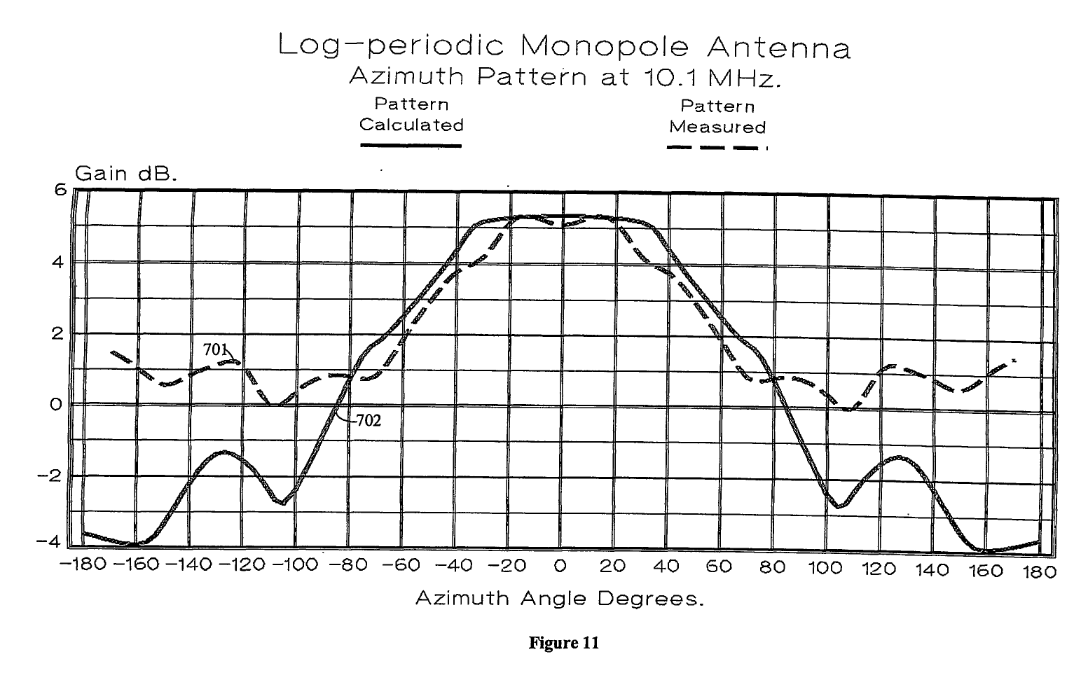

FIGS. 6 to 11 are graphs of the measured 701 and simulated 702 azimuthal radiation patterns for the antenna array at frequencies of 5.1, 6.1, 7.1, 8.1 9.1, and 10.2 MHz, respectively. An azimuthal angle of 0 degrees corresponds to the direction 41 leading from the low frequency end of the antenna array towards the high frequency end of the antenna array, and it can be seen that the maximum gain is obtained in this direction. The simulated radiation patterns 702 include antenna and mismatch losses and appear to match the measured patterns closely. Some discrepancies are apparent at the higher frequencies, probably due to factors such as adjacent buildings and structures that affect surface-wave attenuation.

The antenna 16 is designed to have a limited frequency range of 5-10 MHz, but the high-frequency characteristics of the array can be extended by adding one or more active elements to the high-frequency end of the array. This slightly increases the gain of the fourth antenna element 36 without significantly affecting its impedance.

In comparison with a standard log-periodic antenna array, the logarithmic monopole antenna array 16 has a lower gain and broader azimuth and elevation radiation patterns. However, the cost of manufacture is greatly reduced, and the logarithmic monopole antenna is readily transportable.

Many modifications will be apparent to those skilled in the art without departing from the scope of the present invention as herein described with reference to the accompanying drawings.

1. A transmit antenna for a surface wave radar system, including: a linear array of active monopole antenna elements for transmitting signals in respective frequency ranges, the relative spacings and the relative heights of successive elements along the array having substantially logarithmic relationships; impedance matching circuits for the active monopole antenna elements; and switch means for selecting one of the active antenna elements to transmit a signal in a corresponding frequency range while grounding the remaining active antenna elements.

2. A transmit antenna as claimed in claim 1, wherein the switch means sequentially selects one of said elements.

3. A transmit antenna as claimed in claim 2, wherein the sequential switching is continuous and repeated.

4. A transmit antenna as claimed in claim 1, including passive elements at respective ends of said linear array.

5. A transmit antenna as claimed in claim 4, wherein the relative heights and relative spacings of each passive element and its adjacent active element have logarithmic relationships.

6. A transmit antenna as claimed in claim 1, wherein each active antenna element includes a grounded radial wire counterpoise.

7. A transmit antenna as claimed in claim 6, wherein each radial wire counterpoise forms a substantially semicircular region oriented towards the high frequency end of the antenna.

8. A transmit antenna as claimed in claim 1, wherein said active antenna elements include respective impedance matching networks.

9. A transmit antenna as claimed in claim 8, wherein each of said impedance matching networks includes a capacitor and an inductor in parallel between a transmit signal path and ground.

10. A transmit antenna as claimed in claim 9, wherein at least one of said impedance matching networks includes an inductor in series with said transmit signal path.

11. A transmit antenna as claimed in claim 1, wherein said frequency ranges are of the order of 1 MHz.

12. A transmit antenna as claimed in claim 1, wherein said frequency ranges are substantially equal to 5.0 to 5.7 MHz, 5.7 to 7.1 MHz, 7.1 to 8.15 MHz, and 8.15 to 10.0 MHz.

13. A transmit antenna as claimed in claim 5, wherein the heights of said passive antenna elements are substantially equal to 16.00 m and 6.39 m, respectively.

14. A transmit antenna as claimed in claim 5, wherein the spacings of said passive antenna elements from respective active antenna elements are substantially equal to 13.94 m and 6.97 m, respectively.

15. A transmit antenna as claimed in claim 1, wherein the heights of said active antenna elements are substantially equal to 12.78 m, 10.75 m, 9.04 m, and 7.60 m, respectively.

16. A transmit antenna as claimed in claim 14, wherein the spacings of said active antenna elements are substantially equal to 11.72 m, 9.86 m, and 8.29 m, respectively.
